(19) United States
(12) Patent Application Publication
(10) Pub. No.: US 2022/0055717 A1
(43) Pub. Date: Feb. 24, 2022

(54) HIGH SPEED BIMINI TOP CANVAS

(71) Applicant: Lippert Components, Inc., Elkhart, IN (US)

(72) Inventors: Scott C. MCKINNON, Union City, MI (US); Martin E. FLYNN, Niles, MI (US); Matthew HESS, Goshen, IN (US)

(21) Appl. No.: 17/405,161

(22) Filed: Aug. 18, 2021

Related U.S. Application Data
(60) Provisional application No. 63/068,000, filed on Aug. 20, 2020.

(51) Int. Cl. B63B 17/02

(52) U.S. Cl. CPC B63B 17/02; E05F 15/00

(57) ABSTRACT

A bimini top includes a framework and a canopy secured to the framework. The canopy is formed of a mesh material. The mesh material allows air to flow through the canopy to limit the stresses to the connected structure at high speed. The bimini top may secure a removable and reversible secondary canopy or cover that can provide rain and sun protection under the mesh canopy or may extend forward of the bimini frame when not subjected to high speeds.

### CROSS-REFERENCES TO RELATED APPLICATIONS

This application claims the benefit of U.S. Provisional Patent Application Ser. No. 63/068,000, filed Aug. 20, 2020, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to bimini tops for marine vessels and the like and, more particularly, to bimini tops incorporating a canopy made of a mesh material to facilitate high-speed use in a deployed position and may include a removable and reversible secondary canopy for use when the vessel is not in motion.

Typically, biminis or boat shades have a waterproof canvas cover or shade, but these typical canopy materials are not well-suited for high-speed boating. Generally, these canopies will catch the wind and disrupt air flow, which can slow down the boat or result in potentially unwanted shifting or swaying in transit. As a consequence, users will often stow the canopy during high-speed transit to prevent major damage from occurring to the frame or bimini.

### SUMMARY

It would be desirable to reconfigure the material of the canopy to avoid or reduce the negative effects of airflow at high speeds. In some embodiments, a bimini frame is provided with a canopy formed of a mesh material. The mesh material allows air to flow through the canopy to limit the stresses to the structure at high speeds. In another embodiment, the bimini frame with a mesh canopy may secure a removable and reversible secondary canopy that can provide rain and sun protection under the mesh canopy or may extend forward of the bimini frame when not subjected to high speeds.

In an exemplary embodiment, a bimini top includes a framework, and a canopy secured to the framework, where the canopy is formed of a mesh material. The framework may be displaceable between a deployed position and a retracted position by a motor. The framework may be manually displaceable between a deployed position and a retracted position. The bimini top may further include a secondary cover attached to the framework, where the secondary cover may be attachable to the framework in a folded configuration. In some embodiments, the mesh material is one of a nylon mesh material and a polyester mesh material. The mesh material may be selected based on minimum durability and permeability.

The bimini top may further include a pair of stanchions, and a secondary cover attachable between the framework and the pair of stanchions. In this context, the secondary cover may be displaceable between a canopy extension position and a bimini rain cover position underneath the canopy.

In another exemplary embodiment, a bimini top for a marine vessel configured for high speed operation in a deployed position includes a framework displaceable between the deployed position and a retracted position. The framework has at least one bimini arm extending up and over a passenger cabin. A canopy secured to the framework via the at least one bimini arm is formed of a material that is configured to permit airflow through the canopy.

In yet another exemplary embodiment, a bimini top includes a framework, a canopy secured to the framework, and a secondary cover coupled with one of the framework and the canopy. The secondary cover is selectively deployable for use with the canopy. The bimini top may further include a pouch or housing connected to the one of the framework and the canopy, where the secondary cover is stored in the pouch or housing. The secondary cover may be selectively deployable into a first position overlapping with the canopy to reinforce the canopy and into a second position away from the canopy. The bimini top may include a support leg or stanchion to which the secondary cover is attached in at least one of the first and second position.

### BRIEF DESCRIPTION OF THE DRAWINGS

These and other aspects and advantages will be described in detail with reference to the accompanying drawings, in which:

FIG. 1 shows a marine vessel with an exemplary bimini top in a deployed configuration;

FIG. 2 is a perspective view of the bimini top;

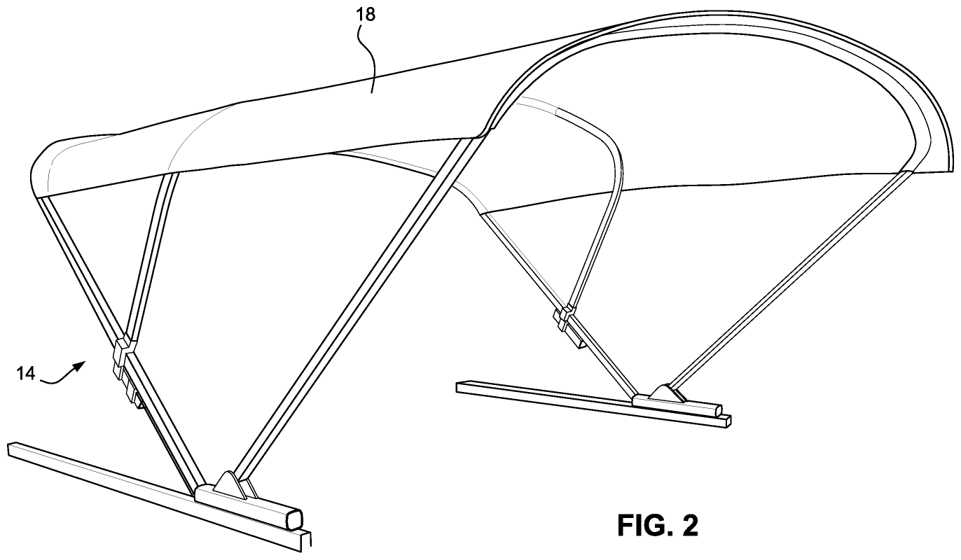

FIG. 3 shows an underside of the bimini top;

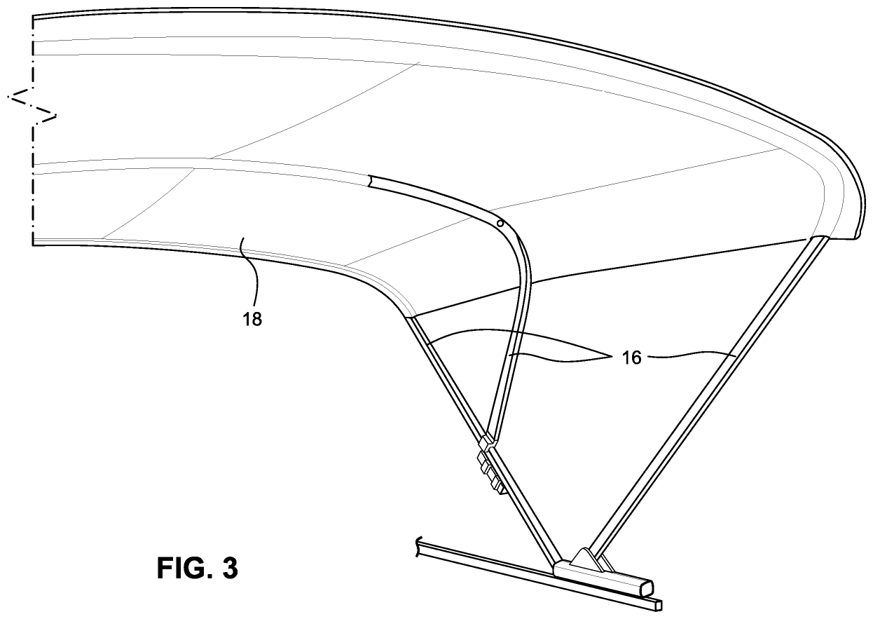

FIG. 4 shows an alternative embodiment of the bimini top with a secondary canopy;

FIG. 5 shows the bimini top with a secondary canopy in a canopy extension position;

FIG. 6 shows a front portion of the bimini top of FIG. 5;

FIG. 7 shows a rear portion of the bimini top of FIG. 5;

FIG. 8 shows a zipper system for installing a secondary canopy to the bimini top;

FIG. 9 is a front view of the bimini top with a secondary canopy in a bimini cover position;

FIG. 10 shows a stanchion and strap for securing the secondary canopy in a deployed position; and

FIG. 11 shows the mounting system of the stanchion of FIG. 10.

### DETAILED DESCRIPTION

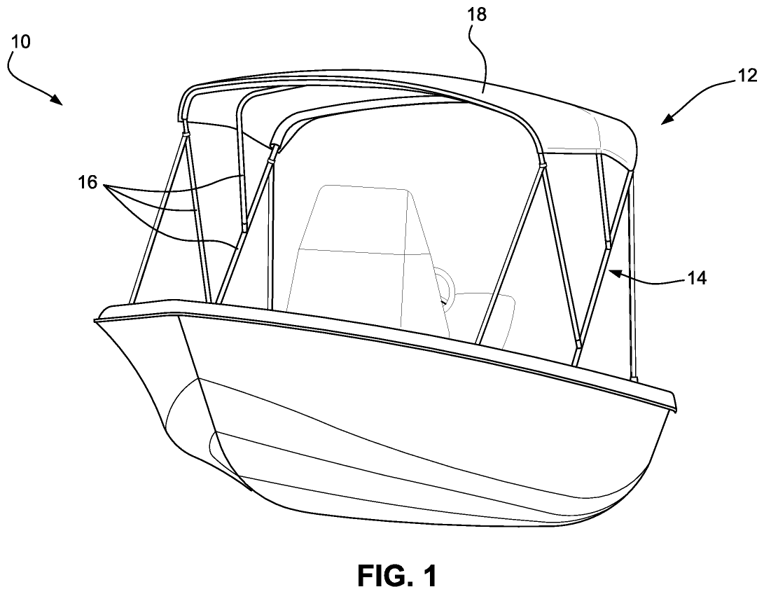

FIG. 1 shows a marine vessel 10 including a bimini top 12 in a deployed position. The bimini top 12 generally includes a framework 14 including an arrangement of bimini arms 16 and a canopy 18 secured to the framework 14. The bimini top 12 serves to provide a sunshade over the passenger cabin. FIG. 1 depicts a speed boat, but the bimini top canvas of the described embodiments is also suitable for pontoon boats or any other marine vessel that is capable of high-speed travel.

The framework is displaceable between a deployed position and a retracted position. In some embodiments, the framework 14 is displaceable by a motor. An exemplary mechanism for deploying and retracting the bimini top 12 is described in U.S. Pat. No. 7,389,737, the contents of which are hereby incorporated by reference. Alternatively, the framework may be manually displaceable between the deployed and retracted positions.

As noted above, with the bimini top 12 in a deployed position, problems may arise at high speeds as the canopy may catch the wind and disrupt airflow, which can slow down the boat or result in potentially unwanted shifting or swaying in transit. In order to obviate this consequence, the canopy 18 according to the described embodiments is formed of a mesh material.

Mesh fabric is produced from connected strands. These strands can be crafted from fibers or any flexible material. The connected threads of the mesh produce a web-like net that has many different uses and applications. Mesh fabrics can be highly durable, strong, and flexible. They are known for and commonly used in scenarios where liquid, air and fine particulate needs permeability.

Mesh fabric may be constructed using polyester (or nylon) and polypropylene. As the fibers are woven together, they create a very flexible, net-type finish that has a tremendous range of end-uses. Mesh fabrics can come in many different sizes, and are numbered for understanding. For instance, a 4-mesh screen indicates that there are 4 “squares” across one linear inch of the screen. A 100-mesh screen indicates that there are 100 openings across one linear inch, and so on. To determine the mesh size, the number of rows of mesh squares within a measured one inch linear space is counted.

The mesh material for the canopy 18 is selected based on minimum durability and permeability to achieve the intended functionality. That is, the mesh material size is selected such that at high speeds, the mesh material allows the air to flow through the canopy 18 to limit stresses to the structure. An exemplary material suitable for the canopy of the described embodiments is made of PVC coated polyester and is configured to substantially block UV rays. The mesh size enables sufficient air flow through the canopy at high speeds to limit stresses to the bimini top structure.

The mesh material canopy 18 is only intended to provide sun shade under the bimini top for a high-speed boat in use. The bimini top 12 may be provided with a secondary canopy or cover 20 that snaps on or is otherwise secured to the framework 14 adjacent the mesh canopy 18 for greater sun coverage or rain cover during low-speed use or when anchored. The secondary canopy 20 can be made of any cloth or polymer material, whether woven or non-woven, that substantially blocks wind, rain, and sun. In some embodiments, the secondary canopy 20 can be a concealed or folded hood (not shown) stored near one end of the bimini framework 14 until needed. In another embodiment, a secondary canopy 20 may be stored in a pouch or housing (not shown) at the front of the bimini top framework 14 for deploying for one or more purposes for low-speed or anchored use of the boat. As shown, the secondary canopy 20 may be stretched rearwardly and secured under the bimini top 12 in an overlapping fashion or it may be extended forward of the bimini top 12 and anchored at the front of the vessel 10. An exemplary embodiment anchors the secondary canopy 20 in either the forward or rearward position by respective support legs and straps. In further embodiments, the secondary canopy 20 may be stretched rearwardly and secured over the bimini top 12. The secondary canopy 20 may also be utilized on a bimini top with a canopy made of canvas or any other suitable material.

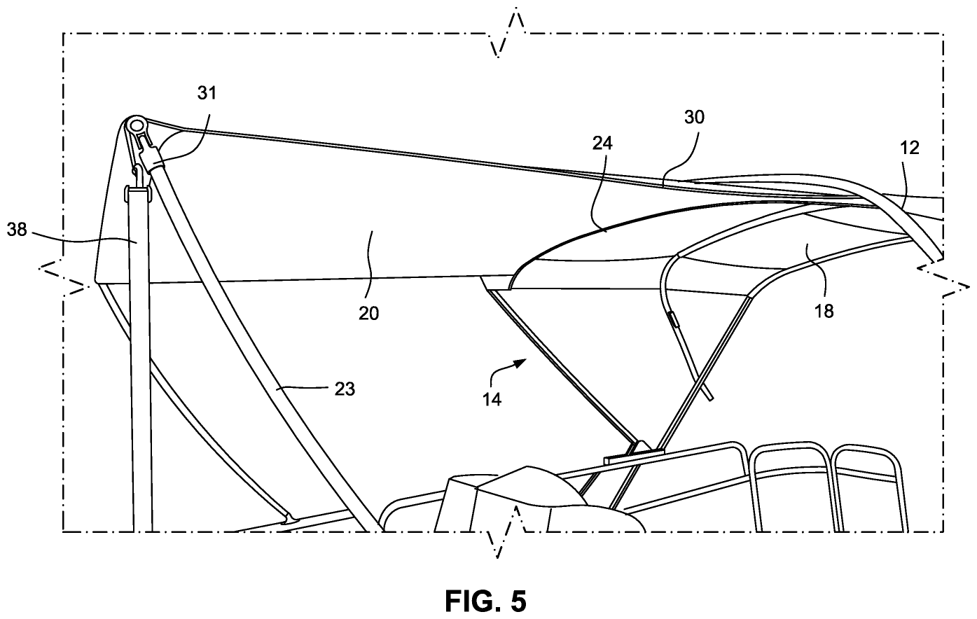

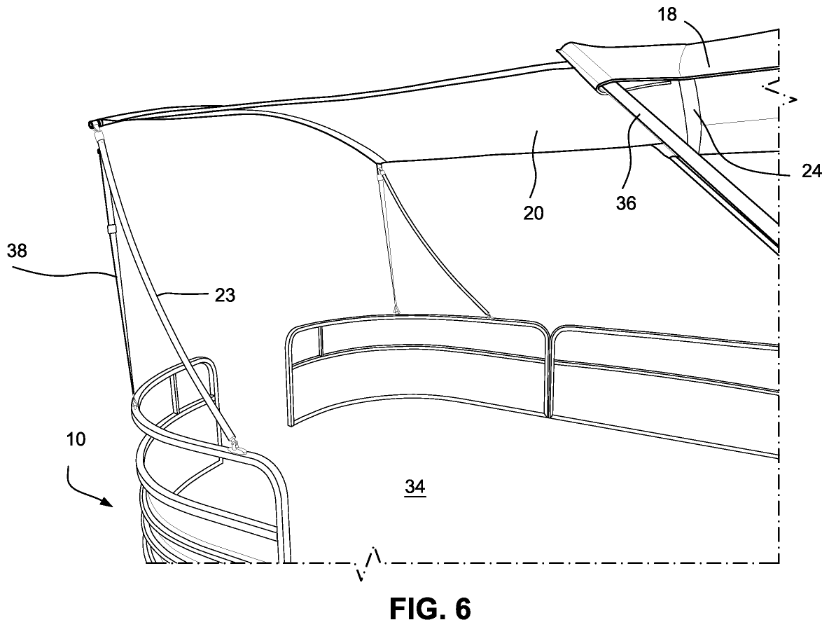

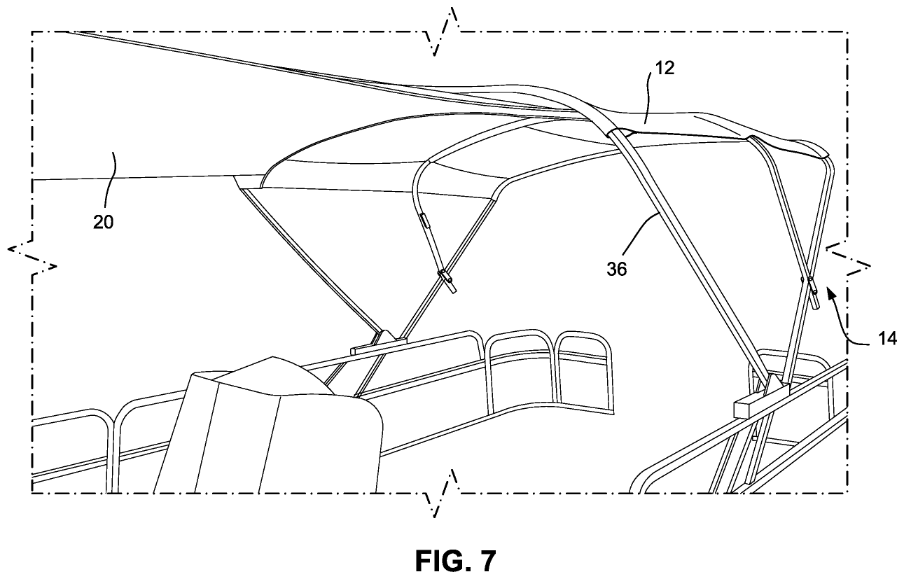

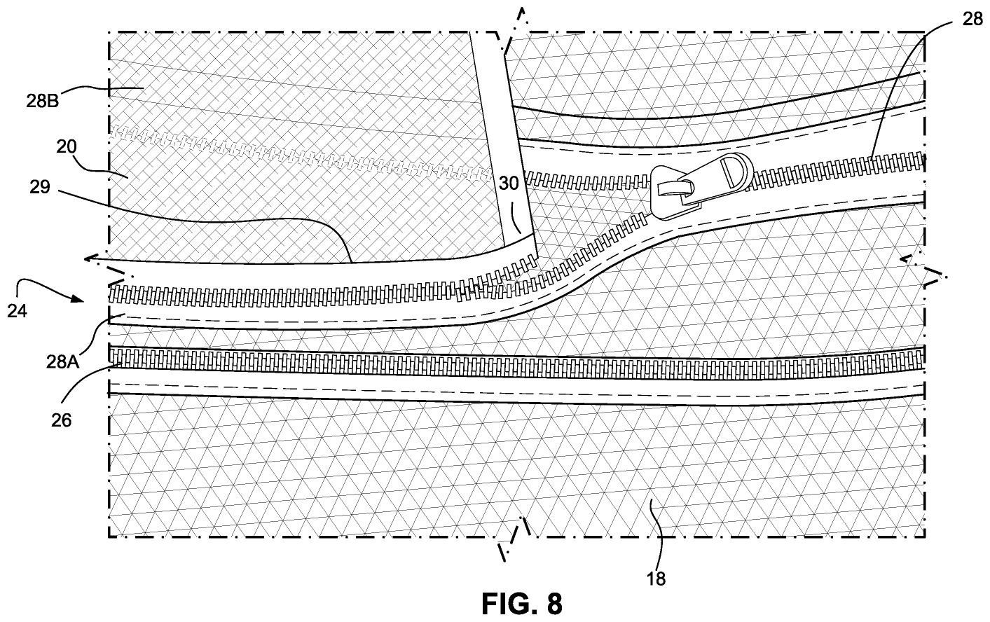

A mesh canopy bimini top with a reversible and removable secondary canopy or cover is further shown in FIGS. 5-9. The secondary canopy 20 may be connected to the underside of the mesh canopy 18 by a zipper system 24, shown in FIG. 8. In the embodiment shown, the mesh canopy 18 is installed onto the bimini framework 14 by connecting and securing the two zipper tape sides of mesh canopy securement zipper 26. The zipper system 24 on the mesh canopy 18 also includes a secondary canopy securement zipper 28 sewn into the mesh canopy with a first zipper tape side 28A and a second zipper tape side 28B. As shown, the secondary canopy securement zipper 28 is preferably located forward of the mesh canopy securement zipper 26 on the mesh canopy 18 so that the secondary canopy 20 may be installed near the front bow 36 of the bimini frame 14. The first and second zipper tape sides 28A, 28B of the secondary canopy securement zipper 28 zip together when the secondary canopy 20 is not installed so that they are taut with the mesh canopy 18 and do not create drag during high-speed use of the boat.

To install the secondary canopy 20, the first and second zipper tape sides 28A, 28B of the secondary canopy securement zipper 28 are unzipped, leaving the teeth of both zipper tape sides exposed. The secondary canopy 20 has a proximal end 30 that includes another zipper tape side 29 that zips into and secures with the second canopy securement zipper tape side 28B of the mesh canopy 18 to securely install the secondary canopy 20.

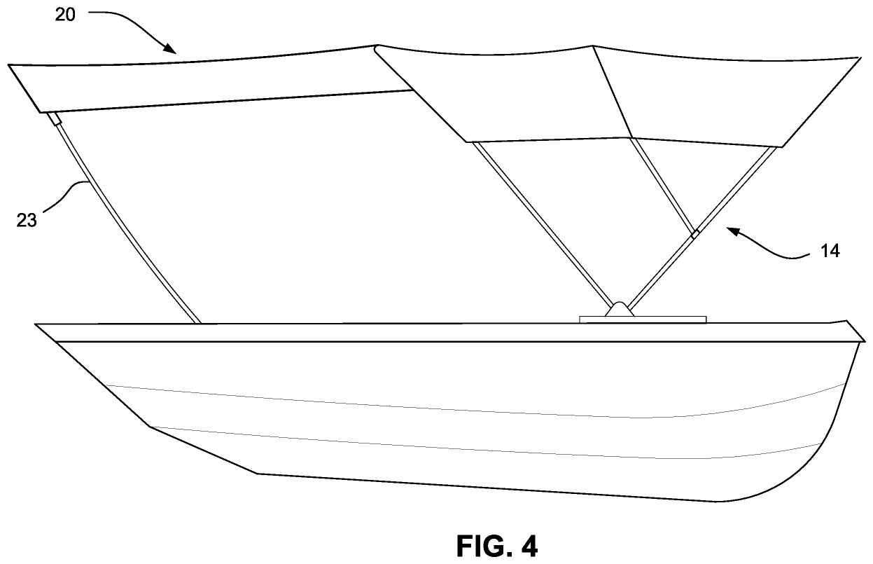

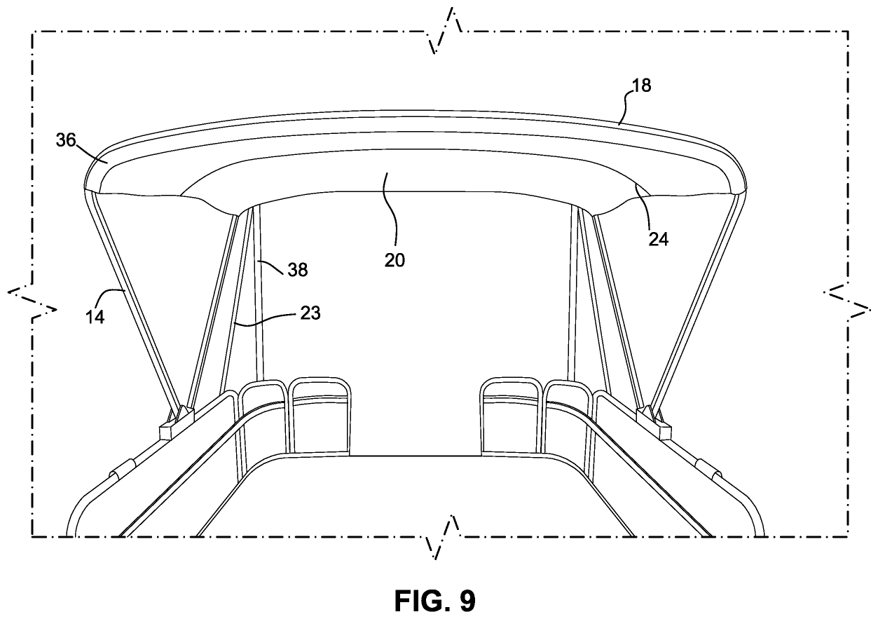

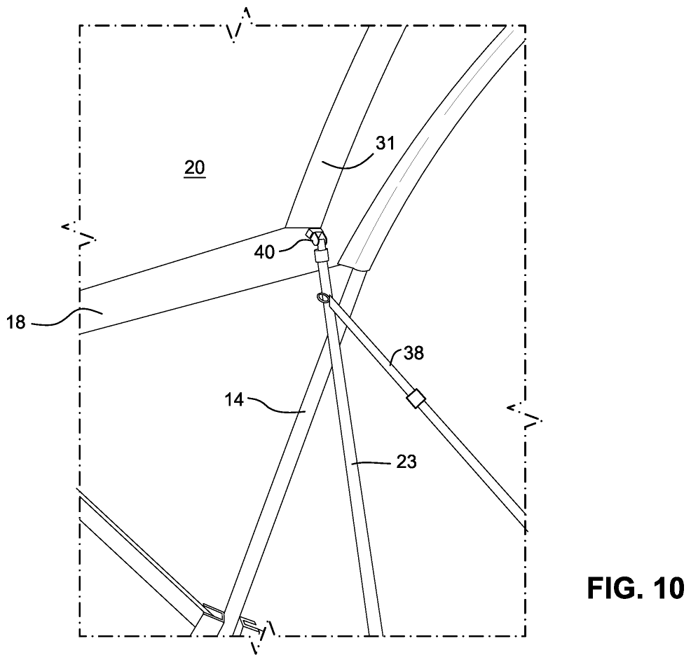

As seen in FIGS. 5-7 and 9, the secondary canopy 20 is connected to the mesh canopy 18 at the zipper system 24 positioned slightly inward of the front bow 36 of the bimini frame 14. In a canopy extension position as shown in FIGS. 4-7, the secondary canopy 20 is stretched forward of the bimini frame 14 to provide sunshade and rain cover to a passenger area 34 that is not under the bimini frame 14. As seen in FIGS. 9-10, the secondary canopy 20 may alternatively extend rearwardly of the zipper system 24 overlapping with or adjacent the underside of the mesh canopy 18 in a bimini rain cover position to provide a rain cover beneath the bimini frame 14.

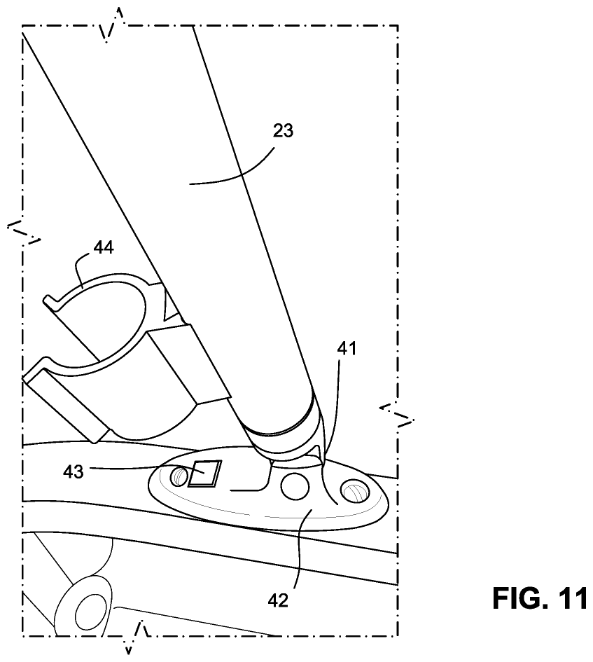

As shown in FIGS. 5-7, 9, and 10, at least one stanchion 23 coupled with at least one strap 38 may be used to secure the secondary canopy 20 in either of the canopy extension position or the bimini rain cover position. In the canopy extension position, a distal end 31 of the secondary canopy 20 may be connected to both sides of the front of the vessel 10 by a pair of stanchions 23 that are releasably connected to the vessel sidewalls and are tensioned by a pair of straps 38. The straps 38 are preferably nylon with adjustable tension buckles 40 that secure to the secondary canopy 20 at one end and releasably couple to the wall or railing of the vessel at the other end. As seen in FIG. 11, the stanchions 23 may have a ball and socket locking mechanism 41 that releasably couples with a railing mounting plate 42 that includes a mechanical release button 43. In the bimini rain cover position, the distal end 31 of the secondary canopy 20 may be connected to opposite sides of the back of the vessel 10 by the same pair of stanchions 23 that are releasably connected to the sidewalls or rear wall of the vessel and are also tensioned by the same pair of straps 38. Although the stanchions 23 and straps 38 are shown and described as the preferred method of securing the distal end of the secondary canopy 20, any suitable securement or mounting means known by a person having ordinary skill in the art may be used.

When the secondary canopy 20 is stowed or otherwise not in use, the stanchions 23 and straps 38 may fold and stow with the secondary canopy 20 inside of the concealed hood or pocket of the zipper system 24. The stanchions 23 may also include a clip 44 for securing to a railing or sidewall of the vessel 10 when not in use.

While the invention has been described in connection with what is presently considered to be the most practical and preferred embodiments, it is to be understood that the invention is not to be limited to the disclosed embodiments, but on the contrary, is intended to cover various modifications and equivalent arrangements.

1. A bimini top comprising:
a framework; and
a canopy secured to the framework, the canopy being formed of a mesh material.

2. A bimini top according to claim 1, wherein the framework is displaceable between a deployed position and a retracted position by a motor.

3. A bimini top according to claim 1, wherein the framework is manually displaceable between a deployed position and a retracted position.

4. A bimini top according to claim 1, further comprising a secondary cover attached to the framework, wherein the secondary cover is attachable to the framework in a folded configuration.

5. A bimini top according to claim 1, wherein the mesh material comprises one of a nylon mesh material and a polyester mesh material.

6. A bimini top according to claim 1, wherein the mesh material is selected based on minimum durability and permeability.

7. A bimini top according to claim 1, further comprising a pair of stanchions, and a secondary cover attachable between the framework and the pair of stanchions.

8. A bimini top according to claim 7, wherein the secondary cover is displaceable between a canopy extension position and a bimini rain cover position underneath the canopy.

9. A bimini top for a marine vessel configured for high speed operation in a deployed position, the bimini top comprising:
a framework displaceable between the deployed position and a retracted position, the framework including at least one bimini arm extending up and over a passenger cabin; and
a canopy secured to the framework via the at least one bimini arm, the canopy being formed of a material that is configured to permit airflow through the canopy.

10. A bimini top according to claim 9, wherein the canopy is formed of a mesh material.

11. A bimini top according to claim 10, wherein the mesh material comprises one of a nylon mesh material and a polyester mesh material.

12. A bimini top according to claim 10, wherein the mesh material is selected based on minimum durability and permeability.

13. A bimini top according to claim 9, wherein the framework is displaceable between the deployed position and the retracted position by a motor.

14. A bimini top according to claim 9, wherein the framework is manually displaceable between the deployed position and the retracted position.

15. A bimini top comprising:
a framework;
a canopy secured to the framework; and
a secondary cover coupled with one of the framework and the canopy, the secondary cover being selectively deployable for use with the canopy.

16. A bimini top according to claim 15, further comprising a pouch or housing connected to the one of the framework and the canopy, wherein the secondary cover is stored in the pouch or housing.

17. A bimini top according to claim 15, wherein the secondary cover is selectively deployable into a first position overlapping with the canopy to reinforce the canopy and into a second position away from the canopy.

18. A bimini top according to claim 17, further comprising a support leg to which the secondary cover is attached in the second position.

19. A bimini top according to claim 15, wherein the canopy is formed of a mesh material.

20. A bimini top according to claim 15, further comprising a pair of stanchions, wherein the secondary cover is displaceable between a canopy extension position connected between the framework and the stanchions and a bimini rain cover position underneath the canopy and secured to the stanchions.
